(19) United States
(12) Patent Application Publication
(10) Pub. No.: US 2025/0045393 A1
(43) Pub. Date: Feb. 6, 2025

(54) BINARY FILE MALWARE DETECTION WITH STRUCTURE AWARE MACHINE LEARNING

(71) Applicant: Palo Alto Networks, Inc., Santa Clara, CA (US)

(72) Inventors: Sujit Rokka Chhetri, San Jose, CA (US); William Redington Hewlett, II, Mountain View, CA (US)

(21) Appl. No.: 18/482,519

(22) Filed: Oct. 6, 2023

Related U.S. Application Data
(60) Provisional application No. 63/516,659, filed on Jul. 31, 2023.

(51) Int. Cl. G06F 21/56

(52) U.S. Cl. CPC G06F 21/565; G06F 21/566

(57) ABSTRACT

A machine learning ensemble receives input data from static analysis and dynamic analysis of binary files to output malicious/benign verdicts for the binary files. The machine learning ensemble comprises a structure aware dynamic compressor (“compressor”). The compressor receives a tree data structure generated based on Application Programming Interface calls of the binary files in various sandbox environments as input. The compressor performs various compression, tokenization, embedding, and reshaping operations to the tree data structure to generate a compressed tensor that preserves structural context from the tree data structure. The machine learning ensemble uses the compressed tensor to generate malicious/benign verdicts for the binary files.

### BACKGROUND

The disclosure generally relates to CPC class G06F and subclass 21/50 and/or 21/56.

Cybersecurity systems analyze binary files for malware detection with static analysis (SA) and dynamic analysis (DA). SA comprises analysis of code in the binary files without running any of the code by analyzing data such as code patterns, attributes and artifacts, flags, and anomalies. DA comprises executing the binary files in a sandbox environment (e.g., a virtual machine) and analyzing runtime behavior. Sandbox environments vary, for instance by emulating distinct operating systems, and DA can execute a binary file in multiple sandbox environments. DA is typically more computationally intensive than SA due to operations for instantiating and tearing down sandbox environments and running binary files therein.

### BRIEF DESCRIPTION OF THE DRAWINGS

Embodiments of the disclosure may be better understood by referencing the accompanying drawings.

FIG. 1 is a schematic diagram of a structure aware binary file malware detection model comprising a structure aware dynamic compressor of tree structure DA data.

FIG. 2 is a schematic diagram of an example structure aware dynamic compressor.

FIG. 3 depicts example API call data encoded in a hierarchical schema and an example tree data structure generated from the example API call data.

FIG. 4 is a flowchart of example operations for detecting malware binary files with structure aware data transformations.

FIG. 5 is a flowchart of example operations for generating dynamically compressed structure aware tokens from a tree data structure.

FIG. 6 is a flowchart of example operations for training a structure aware dynamic compressor and a machine learning model as an ensemble.

FIG. 7 depicts an example computer system with a structure aware dynamic compressor and a structure aware malware detection model.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

SA and DA of binary files can generate logs with thousands or millions of lines, posing a logistical challenge of extracting and analyzing meaningful features of the logs for malware detection. DA logs application programming interface (API) calls for a binary file running in a sandbox for an operating system (OS), and logs from DA can have hierarchical schema. Blindly parsing log files to extract strings by order of occurrence and tokenizing the extracted strings with natural language processing (NLP) loses structural awareness of the hierarchical schema, which can result in lower quality inputs to machine learning (ML) models predicting malware in binary files. This disclosure presents a structure aware binary file malware detection model (“model”) comprising a ML architecture with three pipelines-a first with SA and DA behavioral data as inputs, a second with API call data generated from the DA behavioral data represented as tree data structures as inputs, and a third with sequences of API calls as inputs. Using the API call data as inputs captures hierarchical schema present in the DA behavioral data. For each binary file, a cloud firewall performs DA with multiple sandbox environments for multiple operating systems, and the model takes DA data for each OS paired with SA data as inputs. Subsequent to the three pipelines, the ML architecture comprises a max layer having the outputs from the three pipelines for each operating system as inputs and a dense layer that accepts inputs corresponding to outputs of the max layer to obtain a verdict that the binary file comprises malware.

The second pipeline having tree data structure API call data as inputs comprises a structure aware dynamic compressor (“compressor”). The compressor traverses each tree data structure with a tree search algorithm to generate a structure aware representation of strings at nodes of the tree. The compressor then fuses non-leaf strings in the structure aware representations to generate fused strings, applies a dictionary mapping to the fused strings, and concatenates the dictionary mappings with byte pair encodings of the leaf strings to generate a ragged tensor. The compressor embeds each row of the ragged tensor corresponding to a path in the tree data structure with an embedding tuned during training of the model. Finally, the compressor performs dynamic compression on the ragged tensor with a ratio that depends on height of the ragged tensor relative to a threshold parameter and reshapes the compressed ragged tensor for inputting to a convolutional neural network (CNN) in the second pipeline. Structure aware dynamic compression reduces input data to the model per-binary file while preserving structural context related to tree structures of the input data, resulting in efficient, high quality malware predictions at scale.

### Terminology

A “token” as used herein refers to an identifier or value derived from a string. Tokens can comprise numerical values, strings with extracted from text data separated by delimiter characters (e.g., whitespaces and punctuation) with certain American Standard Code for Information Interchange (ASCII) characters removed, numerical embeddings of strings with natural language processing (NLP), any combination thereof, etc.

The term “static compression” as used herein refers to compression at a fixed compression ratio for potentially variably sized inputs. By contrast, “dynamic compression” as used herein refers to compression with a compression ratio that varies with respect to input size and other hyperparameters.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Example Illustrations

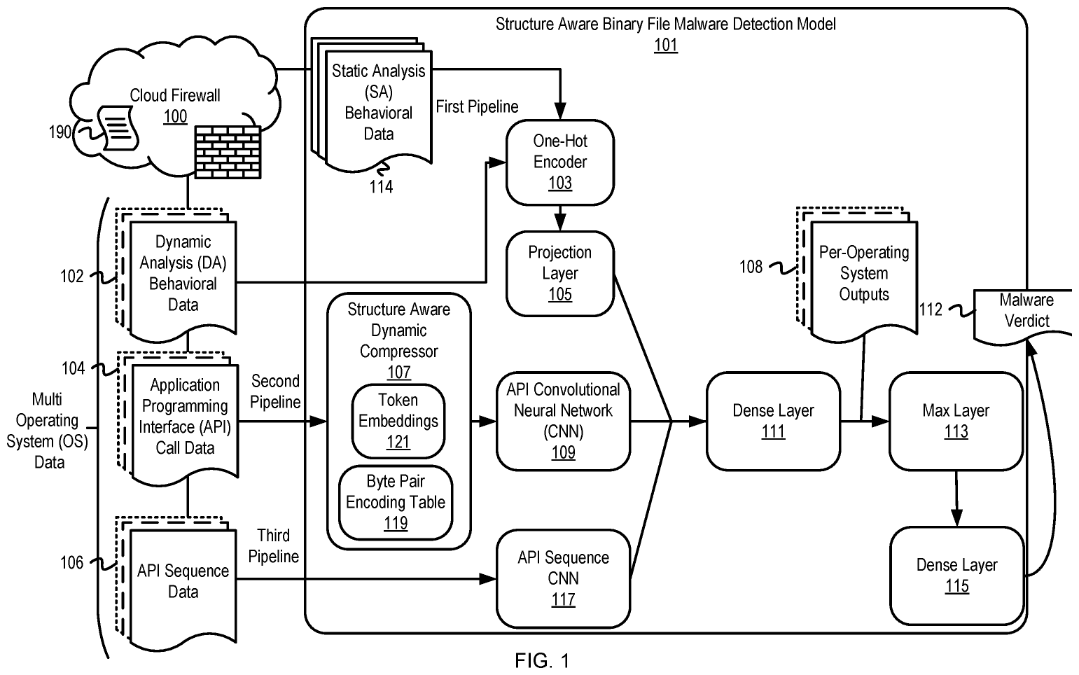

FIG. 1 is a schematic diagram of a structure aware binary file malware detection model comprising a structure aware dynamic compressor of tree structure DA data. A structure aware binary file malware detection model (“model”) 101 comprises three pipelines-a first pipeline comprising a one-hot encoder 103 and a projection layer 105 that takes SA behavioral data 114 and DA behavioral data 102 as input, a second pipeline comprising a structure aware dynamic compressor (“compressor”) 107 and an API CNN 109 that takes API call data 104 as input, and a third pipeline comprising an API sequence CNN 117 that takes API sequence data 106 as input, wherein each of the data inputs are generated for a binary file 190. The DA behavioral data 102, API call data 104, and API sequence data 106 are generated by a cloud firewall 100 with DA in sandboxed environments for multiple operating systems, and data from each sandboxed environment is paired with the SA behavioral data 114 as a separate input to the model 101-a distinct input for each operating system. A dense layer 111 receives concatenated outputs of the three pipelines and outputs per-operating system outputs 108. A max layer 113 receives a concatenation of the per-operating system outputs 108 and feeds into a dense layer 115 that outputs a malware verdict 112.

The SA behavioral data 114 comprises data from SA of code in the binary file 190 such as code length data, section length data, number of code sections, presence of digital signatures and security directories for Portable Executable (PE) files, SA verdicts, etc. The DA behavioral data 102 comprises data from dynamic code analysis of the binary file 190 in a sandbox such as API call statistics, dynamic-link library (DLL) call statistics, identifiers of DA packages running the sandbox corresponding to an operating system, etc. The one-hot encoder 103 converts categorical data in the SA behavioral data 114 and the DA behavioral data 102 into one-hot vectors, and the projection layer 105 comprises a dense layer that projects one-hot encodings output by the one-hot encoder 103 into a vector for inputting to the dense layer 111.

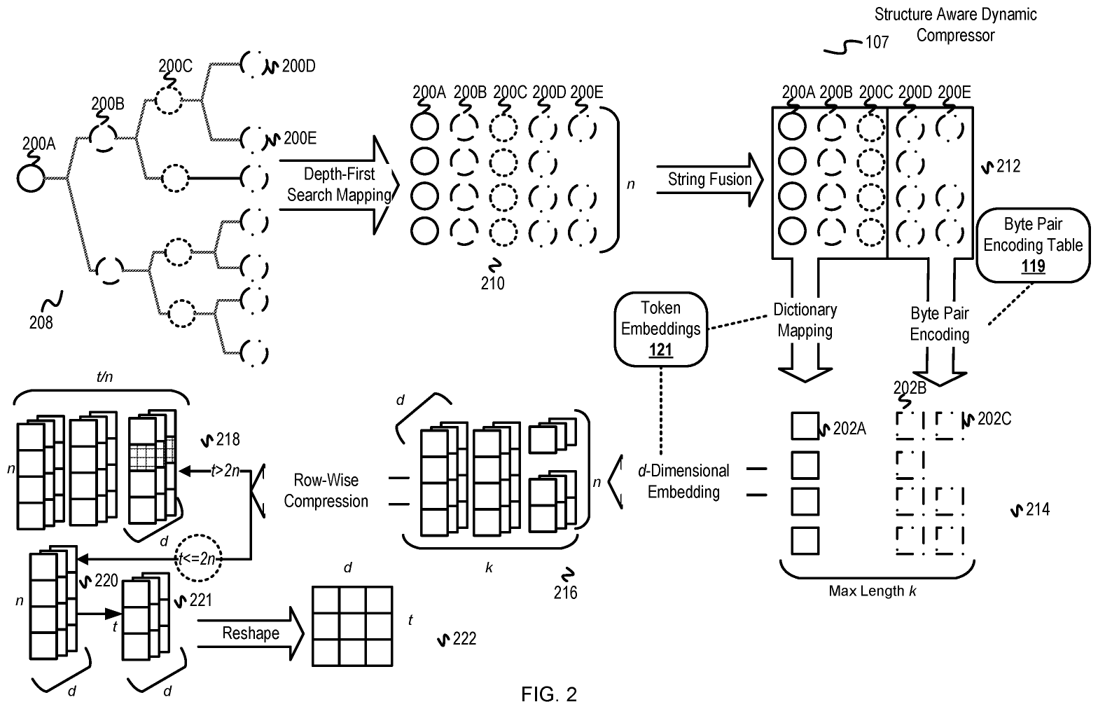

The API call data 104 comprises data for API calls identified during DA of the binary file 190. The cloud firewall 100 encodes the API call data 104 according to a hierarchical schema, e.g., a JavaScript® Object Notation (JSON) file. The compressor 107 compresses the API call data 104 while preserving structural context from the hierarchical schema using token embeddings 121 and a byte pair encoding table 119. Details for compressing the API call data 104 as well as an example hierarchical schema are provided in FIG. 2. The API CNN 109 comprises a CNN with 1-dimensional convolutional layers and has an architecture that can vary by implementation of the model 101 with respect to number, size, and type of layers. The API sequence data 106 comprises sequences of API call identifiers and/or call types extracted from the API call data 104. The cloud firewall 100 scrubs the hierarchical schema of the API call data 104 and extracts sequences of strings for API calls by order of occurrence when generating the API sequence data 106; in other examples, the cloud firewall 100 can generate the API sequence data 106 from the DA behavioral data 102. The API sequence CNN 117 comprises a CNN with one or more 1-dimensional convolutional layers, and the architecture can also vary with respect to number, size, and type of layers depending on implementation.

Each of the three ML pipelines and subsequent layers, including the token embeddings 121 and the byte pair encoding table 119, can be trained as an ensemble by backpropagating loss through each layer of the model 101. The model 101 is trained on SA and DA data (i.e., the inputs 114, 102, 104, and 106) for binary files with known malicious/benign labels. The cloud firewall 100 trains the model 101 until training criteria are satisfied, e.g., until training/testing/validation error are sufficiently low, internal parameters converge across batch training iterations, a threshold number of batches/epochs is reached, etc. The architecture of the model 101 depicted in FIG. 1 is provided as a preferred embodiment for detecting malware binary files. Different architectures for the model 101 and different formats for inputs (e.g., by removing one or more of the ML pipelines or adding additional pipelines) can be implemented. To exemplify, the API sequence CNN 117 can alternatively be a recurrent neural network.

FIG. 2 is a schematic diagram of an example structure aware dynamic compressor. The compressor 107 receives API call data 104 and converts the API call data 104 into a tree data structure according to the hierarchical schema to which the API call data 104 corresponds. For instance, for a JSON file, the compressor 107 can add a child node based on detecting a “{” character, then traverse to the child node. Based on detecting a “}” character, the compressor can traverse to a parent node of the current node. An example tree data structure 208 comprises a root (i.e., depth 0) node 200A, a depth 1 node 200B, a depth 2 node 200C, and depth 3 nodes 200D and 200E. Each node has an associated string based on a field in the hierarchical schema. The compressor 107 performs a graph traversal algorithm (e.g., depth-first search) for the example tree data structure 208 to generate sequences of strings at nodes at each path, with strings for leaf nodes in a path added to the same path sequence rather than multiple path sequences corresponding to a same parent node depth(s). To exemplify, although leaf nodes 200D and 200E are in different structural paths of the example tree data structure 208, because they share a same parent node, example paths 210 comprises a path with nodes 200A, 200B, 200C, 200D, and 200E. In some embodiments, the compressor 107 generates the example paths 210 simultaneous to generating the example tree data structure 208. The compressor 107 generates n paths, with n=4 in the depicted example.

The compressor 107 then fuses strings in each of the example paths 210, with strings at non-leaf nodes in each path fused as separate strings from strings fused at leaf nodes. “String fusion” in this context refers to concatenating the strings at nodes in sequence according to the example path 110 to obtain a single string for each sequence of fused strings. The compressor maps the fused strings for non-leaf nodes to tokens with a dictionary mapping in the token embeddings 121 and performs byte pair encoding on a string for each leaf node of each path with a byte pair encoding table 119 to generate a byte pair encoding token for each leaf node. In the depicted example, the compressor 107 fuses strings at nodes 200A, 200B, and 200C into a single fused string and uses the dictionary mapping in the token embeddings 121 to map the fused string to token 202A in example tokens 214 and performs byte pair encoding on strings at nodes 200D and 200E to generate tokens 202B and 202C, respectively. The maximum number of tokens for each path is k, with k=3 for the depicted example. Due to variable numbers of tokens for each path, the example tokens 214 can be stored in a malleable data structure such as a ragged tensor. In the depicted example, strings at leaf nodes 200D and 200E are not fused prior to byte pair encoding, although for other embodiments these strings can also be fused.

The compressor 107 embeds each of the example tokens 214 with a d-dimensional embedding (d=3 in the depicted example) stored in the token embeddings 121 to generate example embeddings 216. The compressor 107 then dynamically compresses the example embeddings 216 based on a threshold t (t is the width of the resulting compressed tensor) to generate one of example tensor 218 and example tensor 220. The d-dimensional embedding comprises any embedding that embeds each entry of the example tokens 214 into d dimensions and can be configured to compress numerical vectors and/or strings and configured to handle an extended alphabet defined by the byte pair encoding table 119. To exemplify, for numerical vectors of maximal dimension m, the d-dimensional embedding can comprise a m×d matrix whose entries are tuned during training of the model 101. The d-dimensional embeddings can differ for byte pair encodings and dictionary mappings.

The compressor 107 then statically or dynamically compresses the example embeddings 216 with a ratio that depends on relative size of a tunable threshold parameter/and the number of paths n. The threshold parameter/determines size of compressed outputs by the compressor 107. If t>2n, the compressor 107 performs row-wise dynamic compression on the example embeddings 216 to reduce to the integer ceiling of t/n rows to generate example tensor 218. For the depicted example, for t=any of 9, 10, 11, or 12, the compressor dynamically compresses to integer ceiling of t/n=9/4=3 entries in each row. In this instance, t is large enough that there is no compression and the second row of the example tensor 218 is padded with a third d-dimensional entry. More generally, k can be a larger parameter such that row-wise compression into a vector with t/n entries reduces the number of entries in each row. The compressor 107 dynamically compresses each row by bucketing the entries into t/n buckets with uniform size and taking the average or maximum of entries within each bucket. Other compression algorithms that reduce a higher dimensional vector to a lower dimensional vector such as projections are also anticipated by the present disclosure.

If t<=2n, the compressor 107 statically compresses each row of the example embeddings 216 to a single entry, for instance by averaging or taking the maximum of each row, to generate example tensor 220 with n rows having one entry of dimension d and then dynamically compresses the row entries of the example tensor 220 to generate example tensor 221 with/rows each having one entry of dimension d. The compressor 107 dynamically compresses the row entries by bucketizing the row entries t/n buckets and then compressing each bucket as described in the foregoing.

For both the t>2n and t<=2n cases, the compressor 107 reshapes the resulting tensors, respectively, into a matrix with d columns and/rows (for instance, by flattening the tensors) for subsequent input to a machine learning model. In the depicted example, the equation t<=2n is satisfied, and reshaping is performed on example tensor 221 resulting from operations that occur in this case to generate example matrix 222. In both cases, the resulting example tensors 220, 221 have di total entries, such that reshaping yields a matrix with the same dimensions.

The operations for depth-first search mapping, string fusion, tokenization, embedding, and static/dynamic compression in FIG. 2 are provided as an exemplary embodiment of generating compressed representations of paths in the example tree data structure 208. Other methods of generating compressed tree representations such as adding preprocessing steps, omitting preprocessing steps, combining or altering certain steps (for instance, fusing strings for entire paths rather than separating leaf/non-leaf nodes), compressing with different ratios and algorithms, etc. are anticipated by the present disclosure. The compressor 107 is configured to generate compact representations that preserve hierarchical structure of API call data as captured by the example tree data structure 208, and alternative embodiments can comprise any compressed/compact representations that preserve hierarchical structure as opposed to linear analysis methods that parse API calls by order of occurrence without capturing hierarchical structure. In the example depicted in FIG. 2, a single path is shorter than the other paths and as a result the corresponding row in example tensor 218 is padded with zeroes. More generally, when generating tensors such as example tensor 218 that are reshaped into a t×d matrix, any rows that are smaller than the maximum row size are padded with zero entries.

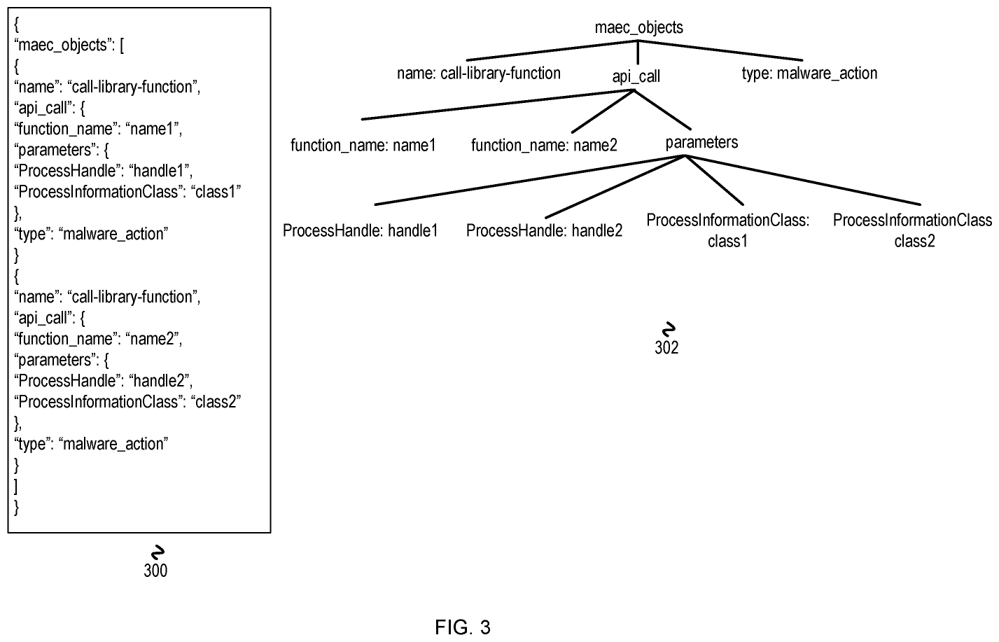

FIG. 3 depicts example API call data encoded in a hierarchical schema and an example tree data structure generated from the example API call data. Example API call data 300 comprises:

{
“maec_objects”: [
{
“name”: “call-library-function”,
“api_call”: {
“function_name”: “name1”,
“parameters”: {
“ProcessHandle”: “handle1”,
“ProcessInformationClass”: “class1”
},
“type”: “malware_action”
}
{
“name”: “call-library-function”,
“api_call”: {
“function_name”: “name2”,
“parameters”: {
“ProcessHandle”: “handle2”,
“ProcessInformationClass”: “class2”
},
“type”: “malware_action”
}
]
}

The example API call data 300 is encoded as a JSON file. Different hierarchical schema can be implemented and can depend on DA applied to binary file code to generate the example API call data 300.

An example tree data structure 302 generated from the example API call data 300 (e.g., by a component in the cloud firewall 100 in FIG. 1 performing DA) comprises a root node “maec_objects” with child nodes “name: call-library-function”, “api_call”, and “type: malware_action”. The “api_call” node has child nodes “function_name: name1”, “function_name: name2”, and “parameters”. The “parameters” node has child nodes “ProcessHandle: handle1”, “ProcessHandle: handle2”, “ProcessInformationClass: class1”, and “ProcessInformationClass: class2”. The example tree data structure 302 is generated from the example API call data 300 by removing extraneous syntax such as quotation marks and following the hierarchical schema to determine child nodes—“{” indicates generating a child node of the current node and traversing to that node in the example tree data structure 302, and “}” indicates traversing to the parent node of the current node.

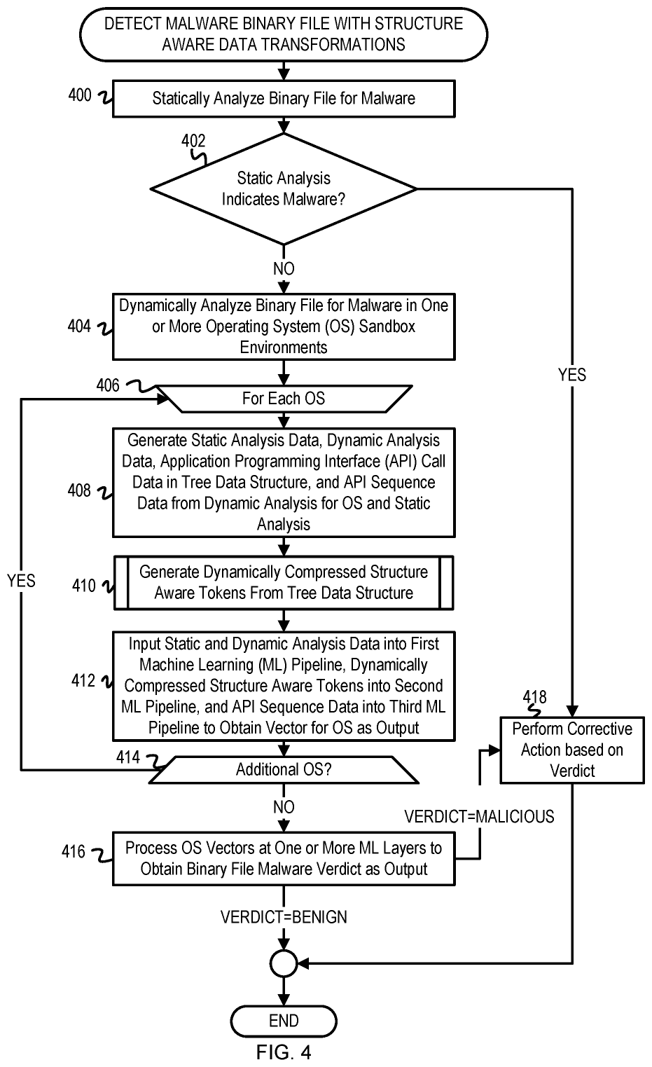

FIGS. 4-6 are flowcharts of example operations for detecting malware binary files with structure aware data transformations in a ML architecture and training the structure aware data transformations and ML architecture as an ensemble. The example operations are described with reference to a structure aware binary file malware detection model (“model”), a cloud firewall, and a structure aware dynamic compressor (“compressor”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 4 is a flowchart of example operations for detecting malware binary files with structure aware data transformations. At block 400, a cloud firewall statically analyzes a binary file for malware. The binary file comprises a binary file identified for malware detection by the cloud firewall, for instance a binary file detected in memory at an endpoint device (e.g., by an agent with which the cloud firewall communicates) or a binary file intercepted in the cloud. SA involves analysis of data such as code length data, section length data, number of code sections, presence of digital signatures and security directories for PE files, SA verdicts, etc. without executing the binary file.

At block 402, the cloud firewall determines whether the SA indicates malware. If the SA indicates malware, operational flow proceeds to block 404. Otherwise, operational flow skips to block 418.

At block 404, the cloud firewall dynamically analyzes the binary file for malware in one or more OS sandbox environments. The cloud firewall instantiates the one or more OS sandbox environments (e.g., as virtual machines) and generates logs tracking behavior in the one or more sandbox environments as the binary file executes in each. The logs comprise runtime behavior data such as API call data, DLL call data, process data, and/or other Malware Attribute Enumeration and Characterization (MAEC) objects. The data for API calls, DLL calls, and processes can comprise timestamps, identifiers, type identifiers, etc.

At block 406, the cloud firewall begins iterating through operating systems for sandbox environments where the binary file was executed. At block 408, the cloud firewall generates SA data, DA data, API call data in a tree data structure, and API sequence data from the DA for the OS and SA. The SA data and DA data can comprise logs from SA and DA, and the cloud firewall can parse the logs to extract tokens to include in the SA data and DA data. The cloud firewall can trim the SA and DA logs (for instance, to remove certain types of MAEC objects) when they are prohibitively large. The DA data is specific to the OS whereas the SA data is uniform across operating systems, and the cloud firewall can generate the SA data asynchronously to iterations for generating DA data for each OS. Logs from DA for the OS comprise API call data encoded in a hierarchical schema such as a JSON file. The cloud firewall generates the tree data structure based on hierarchical relationships between strings indicated in the hierarchical schema, wherein each node of the tree data structure corresponds to a string. The API sequence data comprises sequences of identifiers of API calls by order of occurrence in the DA logs.

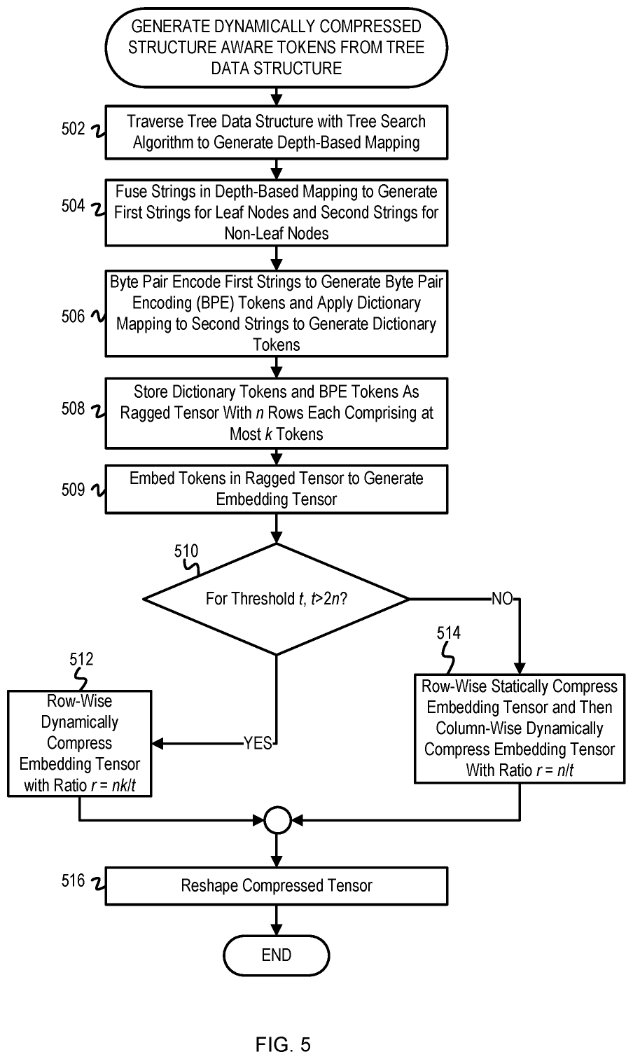

At block 410, a structure aware dynamic compressor (“compressor”) generates dynamically compressed structure aware tokens from the tree data structure. The operations at block 410 are described in greater detail in reference to FIG. 5.

At block 412, the cloud firewall inputs the SA and DA data into a first ML pipeline of a structure aware binary file malware detection model (“model”), the dynamically compressed structure aware tokens into a second ML pipeline of the model, and the API sequence data into a third ML pipeline to obtain a vector for the OS as output. The first ML pipeline comprises a one-hot encoder that feeds into a dense projection layer. The second ML pipeline comprises an API CNN that comprises one or more 1-dimensional convolutional layers. The third ML pipeline comprises an API sequence CNN comprising one or more 1-dimensional convolutional layers. The model concatenates outputs for the three ML pipelines and inputs the concatenated outputs into a dense layer to obtain a vector for the OS as output. At block 414, the cloud firewall continues iterating through operating systems. If the binary file was executed in a sandbox environment for an additional OS, operational flow returns to block 406. Otherwise, operational flow proceeds to block 416.

At block 416, the model processes vectors for each OS at one or more ML layers to obtain and binary file malware verdict as output. For instance, the model can concatenate the vectors for each OS and input the concatenation into a max layer that feeds into a dense layer the generates the binary file malware verdict. The model and compressor as well as the max and dense layers were trained as an ensemble with SA and DA data, API call data, and API sequence data for binary files with known malicious/benign verdicts. If the binary file malware verdict indicates the binary file is malicious, operational flow proceeds to block 418. Otherwise, operational flow in FIG. 4 is complete.

At block 418, the cloud firewall performs corrective action based on the verdict. Corrective action can vary in severity depending on confidence of the malicious verdict as well as context where the binary file was detected by the cloud firewall. For instance, the cloud firewall can delete the binary file from memory and notify users and/or administrators with access to the binary file. The cloud firewall can additionally analyze entities that communicated the binary file, analyze execution of the binary file, etc.

FIG. 5 is a flowchart of example operations for generating dynamically compressed structure aware tokens from a tree data structure. As a preferred embodiment, the tree data structure is generated from API call data logged from DA of a binary file in a sandbox environment. At block 502, a structure aware dynamic compressor (“compressor”) traverses the tree data structure with a tree search algorithm to generate a depth-based mapping. For instance, the compressor can traverse the tree data structure with depth-first search or breadth-first search. The depth-based mapping comprises a list of string sequences for strings at nodes in the tree data structure. Each string sequence comprises one of a path from root to a non-leaf node in the tree data structure that has leaf children and a set of child leaf nodes of the non-leaf node.

At block 504, the compressor fuses strings of the depth-based mapping to generate first strings for leaf nodes and second strings for non-leaf nodes for each string sequence. For instance, the compressor can, for each string sequence, fuse strings in the sequence for the non-leaf nodes and fuse strings in the sequence for the leaf nodes by concatenating the strings into a single string with a white space or other delimiting character.

At block 506, the compressor byte pair encodes the first strings to generate byte pair encoding (BPE) tokens of each string and applies a dictionary mapping to the second strings to generate dictionary tokens. Both tokenization operations reduce the size of the first strings and the second strings. The compressor learns a BPE table that maps character sequences to placeholder characters not present as characters in the first strings and the dictionary mapping that maps strings to tokens during ensemble training of the compressor with a structure aware binary file malware detection model by backpropagating loss, for instance the models described in the foregoing.

At block 508, the compressor stores the dictionary tokens and BPE tokens as a ragged tensor with n rows each comprising at most k tokens. The compressor can alternatively store the dictionary tokens and BPE tokens with any data structure that can store variably sized data. The parameter n is the number of string sequences extracted from the tree data structure and the parameter k is the maximum number of BPE tokens for one of the string sequences plus one (with the plus one representing the dictionary token in the dictionary tokens corresponding to the string sequence).

At block 509, the compressor embeds tokens in the ragged tensor to generate an embedding tensor. The compressor embeds each token of the ragged tensor in d-dimensional space. As with the BPE table and dictionary mapping in the foregoing, the compressor learns the d-dimensional embeddings during ensemble training with one of the foregoing models.

At block 510, the compressor determines whether, for a threshold t, f>2n. t is a parameter that determines the size of the compressed tensor generated from the embedding tensor. If >2n, operational flow proceeds to block 512. Otherwise, operational flow proceeds to block 514.

At block 512, the compressor row-wise dynamically compresses the embedding tensor with ratio r=nk/t. The compressor buckets each row into the integer ceiling of t/n buckets and compresses each bucket into a single entry. The resulting tensor has n rows of/n entries, each entry comprising a d-dimensional vector. Operational flow proceeds to block 516.

At block 514, the compressor row-wise statically compresses the embedding tensor and the column-wise dynamically compresses the embedding tensor with ratio r=n/t. First, the compressor compresses each row of the embedding tensor into a single entry, resulting in a tensor with n rows each having a single d-dimensional entry. Then, the compressor buckets the resulting column into t buckets and compresses each bucket, resulting in a tensor with t rows each having a single d-dimensional entry.

At block 516, the compressor reshapes the compressed tensor into a matrix with t rows and d columns. The compressor can reshape the compressed tensor by flattening its entries.

The foregoing disclosure refers to row-wise and column-wise compression of tensors and, in some instances, compression of rows into single entries. It is to be understood that, because the aforementioned tensors are 3-dimensional, compression occurs along the row or column dimension and not the third embedding dimension represented as parameter d. To exemplify, for row-wise compression, each entry in a row is a d-dimensional vector. Compression of multiple entries in a row within a same bucket comprises entry-wise compression (e.g., entry-wise maximum or averaging) of the vectors for each entry of the d-dimensional vectors.

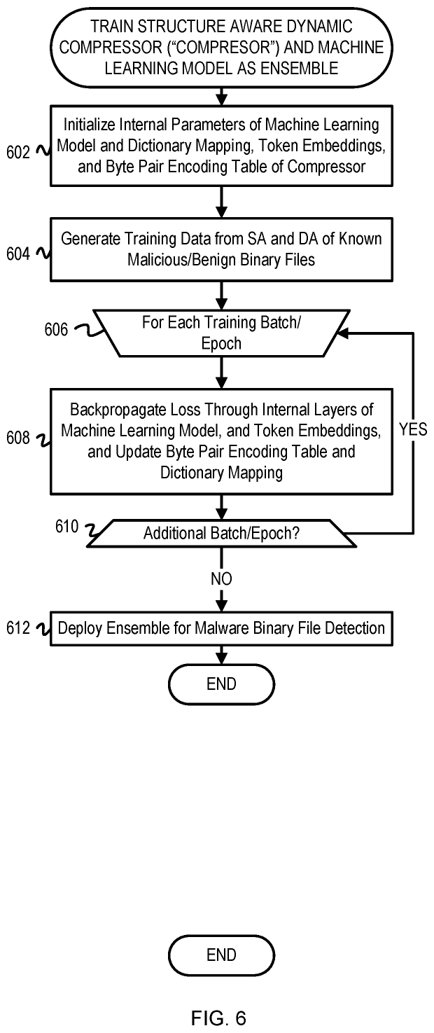

FIG. 6 is a flowchart of example operations for training a structure aware dynamic compressor (“compressor”) and a machine learning model as an ensemble. The compressor can be deployed to preprocess inputs to one of three machine learning pipelines according to the foregoing embodiments. The architecture of the machine learning model can have one or more final layers that take outputs from the previous layers for input data corresponding to multiple operating systems. For these embodiments, during training, the final layers backpropagate loss once across the training data for each operating system and each binary file, whereas the previous layers comprising the three ML pipelines have loss backpropagated for each operating system. Architecture of the machine learning model can be conceptualized as stacked copies of the three ML pipelines, one copy for each OS, and loss is backpropagated through the first stacked copy, the second stack copy is updated with the new parameters after backpropagation through the first stacked copy and then the loss is backpropagated through the second stacked copy, and so on until the loss is backpropagated for each stacked copy. Backpropagation of loss can vary depending on implementation, for instance by maintaining separate copies of the machine learning model prior to the one or more final layers corresponding to each operating system.

At block 602, the machine learning model initializes parameters at its internal layers and the compressor initializes a dictionary mapping, token embeddings, and a BPE table. The compressor initializes the dictionary mapping as an empty mapping with mappings to be populated as new strings are identified during training. The compressor initializes the token embeddings according to a probability distribution (e.g., Gaussian). Finally, the compressor initializes the BPE table as an empty table with entries to be populated as new strings are received by the compressor during training.

At block 604, a cloud firewall or other entity managing training for the ensemble generates training data from DA and SA of known malicious/benign binary files. The cloud firewall can perform the DA for multiple sandbox environments for multiple operating systems. Training data can comprise SA and DA data, API call data generated from the DA, and API sequence data generated from the DA data according to the foregoing embodiments. Labels of training data for each binary file across potentially multiple operating systems indicate whether the binary file is known to be malicious or benign.

At block 606, the cloud firewall begins iterating through training batches/epochs. At block 608, the cloud firewall backpropagates loss for the current batch through internal layers of the machine learning model and the token embeddings and updates the byte pair encoding table and dictionary mapping. The token embeddings comprise layers of a neural network and loss is backpropagated accordingly. The compressor identifies strings at the dictionary mapping in its pipeline not previously seen and initializes new token mappings for the new strings. The token mappings can be generated randomly. In some embodiments, the dictionary mapping also comprises layers of a neural network and is also updated with the backpropagation loss. The compressor additionally determines sequences of characters to replace with placeholder characters based on strings at the current batch and updates the BPE table with mappings between the sequences of characters and the placeholder characters. The placeholder characters can alternatively be numeric values.

At block 610, the cloud firewall determines whether there is an additional batch/epoch of training. For instance, the cloud firewall can determine whether termination criteria are satisfied such as whether training/testing/validation error are sufficiently small, whether a threshold number of batches/epochs has occurred, whether internal parameters of the machine learning model and the compressor converge across training iterations, etc. If the cloud firewall determines there is an additional training batch/epoch, operational flow returns to block 606. Otherwise, operational flow proceeds to block 612.

At block 612, the cloud firewall deploys the trained ensemble for malware detection. Subsequently, the cloud firewall identifies binary files, applies DA/SA to generate input data for the trained ensemble (possibly across multiple sandbox environments for multiple operating systems), and inputs the data into the trained ensemble to obtain malicious/benign verdicts as output.

### Variations

The present disclosure refers variously to tree data structures generated from API call data encoded in a hierarchical schema logged during DA of binary files. Alternatively, any of the ML and structure aware dynamic compression techniques can be applied to tree data structures generated from any security-related data encoded in a tree for malware detection. Moreover, the structure aware dynamic compression algorithm extends to any tree data structures beyond tree data structures generated for cybersecurity. The algorithm provided for structure aware dynamic compression is provided as a preferred embodiment in the context of malware binary file detection. Steps of the algorithm can be altered/omitted, for instance shapes of dynamically/statically compressed tensors, types of tokenization, types of mappings generated from tree traversal, compression methods, etc. can vary in implementation. As a simple example, the depth-first search mapping can generate a unique node sequence for each path in a tree data structure rather than node sequences each comprising multiple paths.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 408, 410, and 412 can be performed in parallel or concurrently for multiple sandboxed operating systems. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

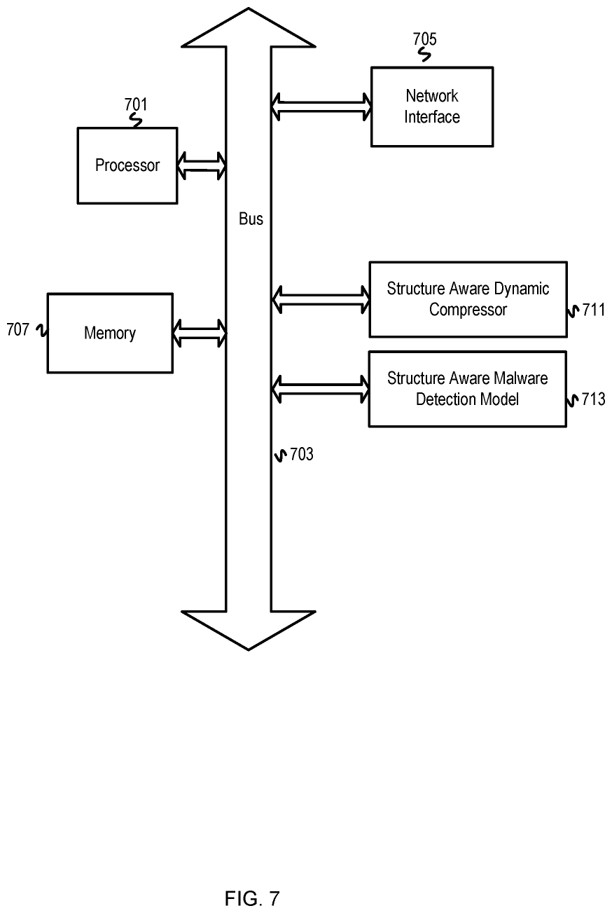

FIG. 7 depicts an example computer system with a structure aware dynamic compressor and a structure aware malware detection model. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes a structure aware dynamic compressor (“compressor”) 711 and a structure aware malware detection model (“model”) 713. The compressor 711 and model 713 are trained as an ensemble and the compressor 711 is implemented to preprocess input with structure aware dynamic compression at one of three ML pipelines for the model 713. The compressor 711 receives API call data represented in a tree data structure as input, wherein the API call data is generated from SA and DA of a binary file that additionally yields input data to the other two ML pipelines. The compressor 711 generates a depth-first search mapping from the tree data structure and applies various natural language processing transformations and compressions to output a compressed tensor of the tree data structure according to the foregoing embodiments. The model 713 receives the compressed tensor output by the compressor 711 and the additional SA/DA data as input and outputs a malicious/benign verdict for the binary file. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
generating a tree data structure comprising, at each node of the tree data structure, a corresponding one of a first plurality of strings, wherein the first plurality of strings comprises strings from dynamic analysis of a binary file;
traversing the tree data structure with a tree search algorithm to generate a plurality of sequences of strings from the first plurality of strings, wherein each of the plurality of sequences of strings corresponds to one or more paths of the tree data structure, wherein each of the one or more paths comprises a path from a root node to a leaf node of the tree data structure;
compressing the plurality of sequences of strings to generate a plurality of compressed representations of the tree data structure; and
inputting the plurality of compressed representations and a second plurality of strings into a machine learning ensemble to obtain as output a verdict indicating whether the binary file is malicious or benign, wherein the second plurality of strings at least comprises strings resulting from static analysis of the binary file.

2. The method of claim 1, wherein the first plurality of strings comprise data of application programming interface calls by the binary file from the dynamic analysis, wherein hierarchical structure of the tree data structure corresponds to hierarchical structure of data for the application programming interface calls.

3. The method of claim 1, wherein compressing the plurality of sequences of strings comprises,
fusing each of the plurality of sequences of strings to generate a plurality of fused strings;
tokenizing each of the plurality of fused strings to generate a plurality of tokens;
embedding each of the plurality of tokens to generate a plurality of embeddings; and
at least one of statically and dynamically compressing the plurality of embeddings to generate the plurality of compressed representations.

4. The method of claim 3, wherein at least one of statically and dynamically compressing the plurality of embeddings comprises at least one of statically and dynamically compressing the plurality of embeddings according to a comparison between a number of paths in the tree data structure corresponding to the plurality of sequences of strings and a threshold parameter, wherein the threshold parameter determines dimensionality of the plurality of compressed representations.

5. The method of claim 1, wherein the first plurality of strings comprises strings from dynamic analysis of the binary file in sandboxes of one or more operating systems, wherein the tree data structure comprises one or more tree data structures for each of the one or more operating systems.

6. The method of claim 1, wherein the machine learning ensemble comprises a first pipeline having the plurality of compressed representations as inputs and one or more pipelines having the second plurality of strings as inputs.

7. The method of claim 1, wherein the tree search algorithm comprises depth-first search or breadth-first search.

8. A non-transitory computer-readable medium having program code thereon comprising instructions to:
dynamically analyze a binary file to generate a tree data structure comprising, at each node in the tree data structure, a string in a first plurality of strings, wherein each of the first plurality of strings comprises first data resulting from the dynamic analysis of the binary file;
compress the tree data structure to generate a plurality of compressed representations of the tree data structure, wherein each of the plurality of compressed representations comprises a compressed representation of one of a plurality of sequences of strings, wherein each of the plurality of sequences of strings comprises strings corresponding to one or more paths in the tree data structure; and
input the plurality of compressed representations and second data into a machine learning ensemble to obtain as output a verdict indicating whether the binary file is malicious or benign, wherein the second data at least comprise data from static analysis of the binary file.

9. The non-transitory computer-readable medium of claim 8, wherein the first plurality of strings comprises data of application programming interface calls by the binary file from the dynamic analysis, wherein hierarchical structure of the tree data structure corresponds to hierarchical structure of data for the application programming interface calls.

10. The non-transitory computer-readable medium of claim 8, wherein the instructions to compress the tree data structure comprises instructions to,
for each sequence of strings of the plurality of sequences of strings,
fuse the sequence of strings to generate one or more fused strings;
tokenize each of the one or more fused strings to generate a one or more tokens; and
embed each of the one or more tokens to generate one or more embeddings; and
at least one of statically and dynamically compress a plurality of embeddings to generate the plurality of compressed representations, wherein the plurality of embeddings comprises the one or more embeddings for each of the plurality of sequences of strings.

11. The non-transitory computer-readable medium of claim 10, wherein instructions to at least one of statically and dynamically compress the plurality of embeddings comprises instructions to least one of statically and dynamically compress the plurality of embeddings according to a comparison between a number of paths in the tree data structure corresponding to the sequences of strings and a threshold parameter, wherein the threshold parameter determines dimensionality of the plurality of compressed representations.

12. The non-transitory computer-readable medium of claim 8, wherein the first plurality of strings comprises strings from dynamic analysis of the binary file in sandboxes of one or more operating systems, wherein the tree data structure comprises one or more tree data structures for each of the one or more operating systems.

13. The non-transitory computer-readable medium of claim 8, wherein the machine learning ensemble comprises a first pipeline having the plurality of compressed representations as inputs and one or more pipelines having the second data as inputs.

14. The non-transitory computer-readable medium of claim 8, wherein the instructions to compress the tree data structure comprises instructions to traverse the tree data structure with a tree search algorithm to obtain the plurality of sequences of strings.

15. An apparatus comprising:
a processor; and
a machine-readable medium having instructions stored thereon that are executable by the processor to cause the apparatus to,
dynamically analyze a binary file to generate a tree data structure comprising, at each node in the tree data structure, a string in a first plurality of strings, wherein each of the first plurality of strings comprises first data resulting from the dynamic analysis of the binary file;
compress the tree data structure to generate a plurality of compressed representations of the tree data structure, wherein each of the plurality of compressed representations comprises a compressed representation of one of a plurality of sequences of strings, wherein each of the plurality of sequences of strings comprises strings corresponding to one or more paths in the tree data structure; and
input at least the plurality of compressed representations into a machine learning ensemble to obtain as output a verdict indicating whether the binary file is malicious or benign.

16. The apparatus of claim 15, wherein the first plurality of strings comprises data of application programming interface calls by the binary file from the dynamic analysis, wherein hierarchical structure of the tree data structure corresponds to hierarchical structure of data for the application programming interface calls.

17. The apparatus of claim 15, wherein the instructions to compress the tree data structure comprise instructions executable by the processor to cause the apparatus to,
for each sequence of strings of the plurality of sequences of strings,
fuse the sequence of strings to generate one or more fused strings;
tokenize each of the one or more fused strings to generate a one or more tokens; and
embed each of the one or more tokens to generate one or more embeddings; and
at least one of statically and dynamically compress a plurality of embeddings to generate the plurality of compressed representations, wherein the plurality of embeddings comprises the one or more embeddings for each of the plurality of sequences of strings.

18. The apparatus of claim 17, wherein the instructions to at least one of statically and dynamically compress the plurality of embeddings comprise instructions executable by the processor to cause the apparatus to least one of statically and dynamically compress the plurality of embeddings according to a comparison between a number of paths in the tree data structure corresponding to the sequences of strings and a threshold parameter, wherein the threshold parameter determines dimensionality of the plurality of compressed representations.

19. The apparatus of claim 15, wherein the first plurality of strings comprises strings from dynamic analysis of the binary file in sandboxes of one or more operating systems, wherein the tree data structure comprises one or more tree data structures for each of the one or more operating systems.

20. The apparatus of claim 15, wherein the machine learning ensemble comprises a first pipeline having the plurality of compressed representations as inputs and one or more pipelines having second data as inputs, wherein the second data at least comprise data from static analysis of the binary file.
